(19) United States
(12) Patent Application Publication
(10) Pub. No.: US 2026/0276938 A1
(43) Pub. Date: Sep. 17, 2026

(54) LENS UNIT, CAMERA MODULE, IMAGING SYSTEM, AND MOBILE BODY

(71) Applicants: Maxell, Ltd., Kyoto (JP); Murata Manufacturing Co., Ltd., Nagaokakyo-shi, Kyoto (JP)

(72) Inventors: Shigehito MITOMA, Kyoto (JP); Yuka TANAKA, Nagaokakyo-shi, Kyoto (JP); Hitoshi SAKAGUCHI, Nagaokakyo-shi, Kyoto (JP); Yuki ISHII, Nagaokakyo-shi, Kyoto (JP)

(73) Assignees: Maxell, Ltd., Kyoto (JP); Murata Manufacturing Co., Ltd., Nagaokakyo-shi, Kyoto (JP)

(21) Appl. No.: 19/168,829

(22) PCT Filed: Mar. 21, 2024
(86) PCT No.: PCT/JP2024/011154

§ 371 Date: Sep. 25, 2025

(30) Foreign Application Priority Data
Mar. 28, 2023 (JP) 2023-051718

(51) Int. Cl. G02B 7/02

(52) U.S. Cl. CPC G02B 7/021

(57) ABSTRACT

A lens unit that includes a lens group in which a plurality of lenses is arranged along an optical axis of the lenses, and a lens barrel that houses and holds the lens group, a black-based metal sheet being bonded to a flat surface facing an image side of a first lens located closest to an object side among the plurality of lenses with an adhesive so that an air layer is not interposed between the flat surface and the metal sheet.

### TECHNICAL FIELD

The present invention relates to a lens unit constituting an in-vehicle camera mounted on a vehicle such as an automobile, a camera module, an imaging system, and a mobile body on which the imaging system is mounted.

### BACKGROUND ART

Conventionally, an in-vehicle camera is mounted on an automobile to support parking and prevent collision by image recognition, and further, attempts have been made to apply this to automatic driving. Further, such a camera module of an in-vehicle camera or the like generally includes a lens unit including a lens group formed by arranging a plurality of lenses along an optical axis, a lens barrel (barrel) that houses and holds the lens group, and a diaphragm member disposed between lenses of at least one part of the lens group (see, for example, Patent Literature 1).

FIG. 6 illustrates an example of a conventional lens unit 100. As illustrated in the drawing, the lens unit 100 includes a cylindrical lens barrel 120 and a plurality of lenses 130, 140, 150, 160, and 170 arranged in an inner accommodating space of the lens barrel 120. These lenses 130, 140, 150, 160, and 170 fixed to and supported by the lens barrel 120 are arranged in a state where their respective optical axes coincide with each other, and are arranged along one optical axis O to constitute one lens group L used for imaging by a package sensor (image sensor; not illustrated) on an image side.

Note that, in FIG. 6, hatching is omitted for the lenses 130, 140, 150, 160, and 170.

In addition, in a form in which such lenses 130, 140, 150, 160, and 170 are incorporated in the inner accommodating space of the lens barrel 120 so as to be stacked in order from the image side toward the object side, adjacent lenses often come into surface contact so as to abut against each other at their seat surfaces. Then, in such a case, particularly with respect to the first and second lenses 130 and 140 adjacent to each other, when the first lens 130 is made of glass and the second lens 140 is made of resin, it is common that ink 210 is applied to a flat surface on the image side of the first lens 130 in contact with the seat surface of a flange of the second lens 140 for the purpose of preventing transmission and reflection of stray light.

### CITATION LIST

### Patent Literature

Patent Literature 1: JP 2013-231993 A

### SUMMARY OF INVENTION

### Technical Problem

Incidentally, as described above, when the ink is applied to the flat surface facing the image side of the first lens, the adhesion strength of the ink to the glass is relatively weak, and thus, when the lens unit is exposed to a high temperature and high humidity environment, the ink may be partially peeled off from the flat surface of the first lens, and in this case, there is a problem that stray light is transmitted and reflected at the peeled portion.

The present invention has been made in view of the above circumstances, and an object thereof is to provide a lens unit, a camera module, an imaging system, and a mobile body capable of preventing transmission and reflection of stray light.

### Solution to Problem

In order to solve the above problems, in the present invention, a lens unit includes a lens group in which a plurality of lenses is arranged along an optical axis of the lenses, and a lens barrel that houses and holds the lens group, in which
a black-based metal sheet is bonded to a flat surface facing an image side of a first lens located closest to an object side among the plurality of lenses with an adhesive so that an air layer is not interposed between the flat surface and the metal sheet.

When the black-based metal sheet is bonded to the flat surface facing the image side of the first lens, ink for preventing transmission and reflection of stray light is not applied to the flat surface. That is, instead of applying the ink, a black-based metal sheet is bonded to the flat surface.

Examples of the black-based metal sheet include a metal sheet of black-treated stainless steel (for example, SUS 304) having a thickness of about 10 to 40 μm.

Further, the black-based metal sheet is not necessarily black, and only needs to have a reflectance that reflects light of a predetermined wavelength (for example, visible light) at a predetermined reflectance or less, and the reflectance only needs to be, for example, equal to or more than 0 and equal to or less than 1%.

Examples of the adhesive include an epoxy-based adhesive having a Young's modulus of 2 to 5 Gpa.

In the present invention, since the black-based metal sheet is bonded to the flat surface of the first lens facing the image side with the adhesive so that the air layer is not interposed between the flat surface and the metal sheet, even if the lens unit is exposed to a high-temperature and high-humidity environment, the metal sheet can be prevented from peeling off from the flat surface of the first lens, and the air layer is not interposed between the flat surface of the first lens and the metal sheet, so that transmission and reflection of stray light can be prevented.

Further, since the metal sheet has a Young's modulus higher than that of the ink, adhesion of the metal sheet to the flat surface of the first lens makes it difficult to absorb vibration as compared with the ink, and as a result, inhibition of vibration of the first lens can be suppressed.

Further, in the configuration of the present invention, the metal sheet may be formed in a sheet shape having an annular surface having the same shape as the flat surface facing the object side of the first lens, and the metal sheet may be bonded to the flat surface with an adhesive so as to entirely cover the flat surface.

With such a configuration, since the metal sheet is bonded to the flat surface by the adhesive so as to cover the entire flat surface of the first lens facing the object side, transmission and reflection of stray light can be more reliably prevented.

In addition, in the above-mentioned configuration of the invention, it is preferable that the adhesive is an epoxy-based adhesive and has a Young's modulus of 2 to 5 GPa.

With such a configuration, transmission and reflection of stray light can be more reliably prevented, and inhibition of vibration of the first lens can be more reliably suppressed.

Further, in the configuration of the present invention, a vibration mechanism that vibrates the first lens may be provided.

With such a configuration, by vibrating the first lens by the vibration mechanism, foreign matter such as water droplets, muddy water, ice and snow, and frost on the lens surface of the first lens can be removed, and the metal sheet has a Young's modulus higher than that of the ink, so that it is difficult to absorb vibration as compared with the ink, and as a result, inhibition of vibration of the first lens can be suppressed.

Further, the present invention also provides a camera module including the lens unit, an imaging system including the camera module, and a mobile body on which the imaging system is mounted. With such a camera module, an imaging system, and a mobile body, it is possible to obtain operations and effects similar to those of the lens unit described above. Note that the “mobile body” refers to all objects that can move, and examples thereof include vehicles and the like.

### Advantageous Effects of Invention

According to the present invention, transmission and reflection of stray light can be prevented, and inhibition of vibration of the first lens can be suppressed.

### BRIEF DESCRIPTION OF DRAWINGS

FIG. 1 illustrates a first embodiment of the present invention, and is a schematic cross-sectional view of a lens unit.

FIG. 2 is a cross-sectional view of a main part of the lens unit.

FIG. 3 is a schematic cross-sectional view of a camera module including the lens unit according to the first embodiment of the present invention.

FIG. 4 is a schematic view of a vehicle as a mobile body on which an imaging system (in-vehicle system) including a camera module according to an embodiment of the present invention is mounted.

FIG. 5 is a block diagram illustrating a configuration of an imaging apparatus constituting the imaging system illustrated in FIG. 4.

FIG. 6 is a schematic cross-sectional view of a conventional lens unit.

### DESCRIPTION OF EMBODIMENTS

Hereinafter, an embodiment of the present invention will be described with reference to the drawings, and the present embodiment contributes to “9.1 Develop quality, reliable, sustainable and resilient infrastructure, including regional and transborder infrastructure, to support economic development and human well-being, with a focus on affordable and equitable access for all” of “9. Build the foundation for industry and technological innovation” of the Sustainable Development Goals (SDGs) proposed by the United Nations.

Note that the lens unit of the present embodiment described below is particularly for a camera module such as an in-vehicle camera, and for example, is fixedly installed on the outer surface side of an automobile, and wiring is drawn into the automobile and connected to a display or other apparatuses.

Note that the lens unit of the present embodiment described below is particularly for a camera module such as an in-vehicle camera, and for example, is fixedly installed on the outer surface side of an automobile, and wiring is drawn into the automobile and connected to a display or other apparatuses. In addition, hatching is omitted for lenses in all the drawings.

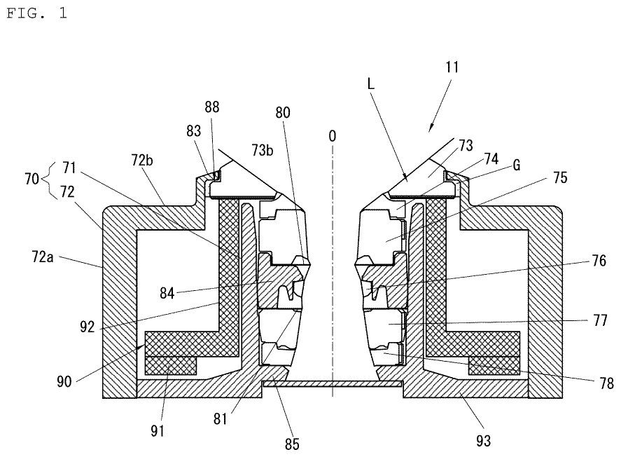

FIG. 1 illustrates a lens unit 11 according to an embodiment of the present invention. As illustrated in the drawing, the lens unit 11 of the present embodiment includes, for example, a cylindrical lens barrel (barrel) 70 made of resin. The lens barrel 70 includes a lens barrel main body 71 and a cap 72 attached to an end of the lens barrel main body 71 on the object side, and a plurality of (for example, 6) lenses 73, 74, 75, 76, 77, and 78, two diaphragm members 80 and 81, and one annular spacer 84 are provided in the lens barrel 70. An in-vehicle camera including this lens unit 11 includes a lens unit 11, a substrate having an image sensor (not illustrated), and an installation member (not illustrated) for installing the substrate in a vehicle such as an automobile.

Further, the first lens 73 located closest to the object side is a glass lens, and the lenses 74 to 78 are resin lenses, but it is not limited thereto (for example, the lens 73 may be a resin lens).

In addition, an antireflection film, a hydrophilic film, a water-repellent film, and the like are provided on the surface of the lenses 73 to 78 as necessary.

The plurality of lenses 73 to 78 fixed to and supported by the lens barrel 70 is arranged in a state where optical axes of the lenses are matched with each other, and the lenses 73 to 78 are arranged along one optical axis O to constitute one lens group L used for imaging.

Of the two diaphragm members 80 and 81, the first diaphragm member 80, counting from the object side (one end of the lens barrel 70), is disposed between the third lens 75, also counting from the object side, and the spacer 84. The second diaphragm member 81, counting from the object side, is disposed between the spacer 84 and the fifth lens 77, counting from the object side.

The diaphragm members 80 and 81 are “aperture diaphragms” that limit the amount of transmitted light and determine an F value to be an index of brightness, or “light-shielding diaphragms” that shield light beams that cause ghosts and light beams that cause aberrations.

Further, in the present embodiment, the cap 72 is disposed on the radially outside the lens barrel main body 71. The cap 72 includes a cylindrical cap main body 72a, an annular plate-like top plate 72b integrally formed with the cap main body 72a at an upper end of the cap main body 72a, and a caulking portion 83 integrally formed with the top plate 72b at an inner diameter edge of the top plate 72b.

A length of the cap 72 in an optical axis direction is substantially equal to a length of the lens barrel main body 71 in the optical axis direction, and the caulking portion 83 protrudes upward from an end (upper end in FIG. 7) of the lens barrel main body 71 on the object side.

In addition, the caulking portion 83 of the end on the object side (the upper end in FIG. 1) is thermally caulked radially inward in a state where the lens group L is incorporated and accommodated and held in the inner accommodating space of the lens barrel 70, whereby the first lens 73 located closest to the object side of the lens group L is fixed in the optical axis direction to an object side end of the lens barrel 70 (object side end of the cap 72) by the caulking portion 83.

Further, an inner flange 85 having an aperture having a diameter smaller than that of the sixth lens 78 is provided at an end (lower end in FIG. 1) of the lens barrel main body 71 on the image side. The plurality of lenses 73 to 78 constituting the lens group L, the diaphragm members 80 and 81, and the spacer 84 are held and fixed in the optical axis direction in the lens barrel 70 by the inner flange 85 and the caulking portion 83.

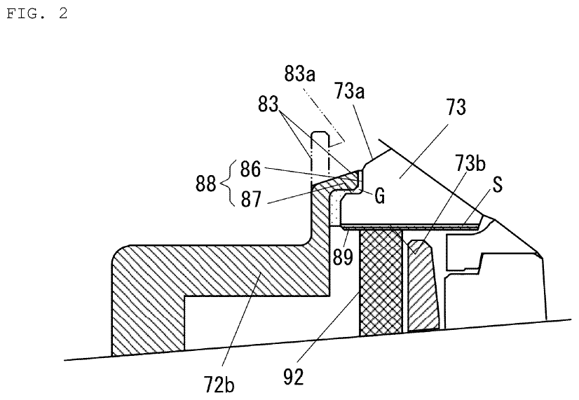

Further, in the present embodiment, as illustrated in FIGS. 1 and 2, a step 88 including a cylindrical surface 86 parallel to the optical axis O and an annular surface 87 orthogonal to the optical axis O is provided on an outer peripheral portion of a surface (lens surface) 73a of the first lens 73 facing the object side. The cylindrical surface 86 is formed coaxially with the optical axis O, an upper end (upper end in the optical axis direction) of the cylindrical surface 86 reaches the lens surface 73a of the first lens 73, and a lower end (lower end in the optical axis direction) of the cylindrical surface 86 is smoothly connected to an inner diameter end of the annular surface 87 by an arc surface. The annular surface 87 is formed coaxially with the optical axis O, and its outer diameter end reaches an outer peripheral surface of the first lens 73. Note that an outer peripheral portion of the annular surface 87 is a chamfered portion, and an outer diameter end of the chamfered portion reaches the outer peripheral surface of the first lens 73.

The step 88 having such a cylindrical surface 86 and an annular surface 87 is formed in a substantially L-shaped cross section on the outer peripheral portion of the surface (lens surface) 73a of the first lens 73 facing the object side, and has an upper side opened to the lens surface 73a of the first lens 73 and a side opened to the outer peripheral surface (outer peripheral side surface) of the first lens 73.

The caulking portion 83 is formed at an opening edge portion provided at a radially central portion of the top plate 72b of the cap 72. The caulking portion 83 before caulking stands in the optical axis direction, and an inner side surface 83a facing the radial inside is directed parallel to the optical axis O. An outer peripheral surface on a lower side (lower side in the optical axis direction) of the annular surface 87 of the step 88 of the first lens 73 is close to a lower end (lower end in the optical axis direction) of the inner side surface 83a, the inner side surface 83a on an upper side (upper side in the optical axis direction) of the annular surface 87 is disposed in parallel with and spaced apart from the cylindrical surface 86, and an upper end thereof protrudes upward from an outer peripheral edge of the lens surface 73a of the first lens 73.

Therefore, the side (radial side) of the step 88 is closed by an outer peripheral surface of the caulking portion 83 on the upper side (upper side in the optical axis direction) of the annular surface 87, and thus, the closed step 88 is filled with an adhesive G before caulking the caulking portion 83. The filling amount of the adhesive G is set to such an amount that the adhesive G does not overflow from the step 88 and cover the outer peripheral edge of the lens surface 73a of the first lens 73 when the caulking portion 83 is caulked. Note that, before caulking the caulking portion 83, the adhesive G with which the step 88 is filled is also filled in a gap below the step 88 (gap between a rising portion of the caulking portion 83 and the outer peripheral surface of the first lens 73).

Then, after the step 88 is filled with the adhesive G, the caulking portion 83 is thermally caulked radially inward so as to cover the surface of the adhesive G, thereby fixing the first lens 73 to the object side end of the lens barrel 70 (object side end of the cap 72) in the optical axis direction. At this time, since the step 88 is closed by the upper end of the caulking portion 83 being caulked radially inward and bent, the adhesive G filled in the step 88 is brought into close contact with the inner side surface 83a of the caulking portion 83 including the bent portion and the cylindrical surface 86 and the annular surface 87 of the step 88, and is cured to bond the first lens 73 to the cap 72 of the lens barrel 70 without any gap. In this manner, the step 88 of the first lens 73 is held by the caulking portion 83 of the cap 72, and the first lens 73 and the subsequent lens 74 to 78 are fixed in the optical axis direction.

Further, in the present embodiment, as illustrated in FIG. 2, a metal sheet 89 is bonded to a flat surface 73b of the first lens 73 facing the image side with an adhesive S so that an air layer is not interposed between the flat surface 73b and the metal sheet 89. The metal sheet 89 is formed in an annular sheet shape by using, for example, metal such as black-treated stainless steel having a thickness of about 10 to 40 μm (for example, 28 μm). The metal sheet 89 is formed in a sheet shape having an annular surface having substantially the same shape as the annular flat surface 73b of the first lens 73, and is disposed coaxially with the optical axis O. Further, the metal sheet 89 is bonded to the flat surface 73b with an adhesive so as to entirely cover the flat surface 73b.

Furthermore, the adhesive S is an epoxy-based adhesive and has a Young's modulus of 2 to 5 GPa. When the metal sheet 89 is bonded to the flat surface 73b of the first lens 73 with an adhesive, it is preferable to use an adhesive having a Young's modulus higher than that of the ink. The Young's modulus of the ink is 2 to 5 GPa, and is substantially the same as that of the adhesive S, but by appropriately selecting the ink and the adhesive S on the basis of the Young's modulus, the adhesive S having a Young's modulus higher than that of the ink can be used.

Therefore, when the metal sheet 89 is bonded to the flat surface 73b with the adhesive S, it is preferable to use the adhesive S having a higher Young's modulus than the ink applied to the flat surface 73b of the conventional first lens. For example, when the Young's modulus of the ink is 2 GPa, it is preferable to use the adhesive S having a Young's modulus of more than 2 GPa and equal to or less than 5 GPa.

As described above, the metal sheet 89 is bonded to the flat surface 73b facing the image side of the first lens 73 located closest to the object side by the adhesive S so that the air layer is not interposed between the flat surface 73b and the metal sheet 89 and the flat surface 73b is entirely covered.

Further, in the present embodiment, as illustrated in FIG. 1, a vibration mechanism 90 that vibrates the first lens 73 is provided.

The vibration mechanism 90 includes a vibrator 91 that performs ultrasonic vibration, and a vibrating body 92 that transmits the ultrasonic vibration of the vibrator 91 to the first lens 73. The vibrator 91 is formed in an annular plate shape and is provided inside the cap main body 72a of the cap 73. The vibrator 91 is formed of, for example, a piezoelectric device.

Further, a bottom plate 93 is provided integrally with the lens barrel main body 71 at an end on the image side (lower end in FIG. 1) of the lens barrel main body 71, the bottom plate 93 is formed in an annular plate shape coaxially with the optical axis O, and an outer peripheral surface thereof is fixed to a lower end inner peripheral surface of the lens barrel main body 71. The vibrator 91 is provided coaxially with the optical axis O on an upper surface of the bottom plate 93, and the vibrating body 92 is fixed to an upper surface of the vibrator 91. The vibrating body 92 is formed in a cylindrical shape coaxial with the optical axis O, and the flat surface 73b facing the image side of the first lens 73 is installed and fixed to an upper end surface (end surface on the object side) of the vibrating body via an adhesive layer formed by the metal sheet 89 and the adhesive S.

In such a vibration mechanism 90, when the vibrator 91 ultrasonically vibrates, the vibrating body 92 ultrasonically vibrates, and the first lens 73 ultrasonically vibrates via the vibrating body 92, whereby foreign matter such as water droplets, muddy water, ice and snow, and frost adhering to the lens surface 73a of the first lens 73 is removed.

As described above, according to the present embodiment, since the metal sheet 89 is bonded to the flat surface 73b of the first lens 73 facing the image side with the adhesive S so that the air layer is not interposed between the flat surface 73b and the metal sheet 73, even if the lens unit 11 is exposed to a high-temperature and high-humidity environment, the metal sheet 89 can be prevented from being peeled off from the flat surface 73b of the first lens 73, and the air layer is not interposed between the flat surface 73b of the first lens 73 and the metal sheet 89, so that transmission and reflection of stray light can be prevented.

In addition, since the metal sheet 89 has a Young's modulus higher than that of the ink, it is difficult to absorb vibration as compared with the ink, and as a result, inhibition of vibration of the first lens 73 can be suppressed.

In addition, since the step 88 including the cylindrical surface 86 and the annular surface 87 is provided on the outer peripheral portion of the surface (lens surface) 73a of the first lens 73 facing the object side, and the step 88 is filled with the adhesive G, the first lens 73 can be adhered to the cap 72 of the lens barrel 70 without any gap by the adhesive G. Then, since the caulking portion 83 covers the adhesive G and fixes the first lens 83 to the lens barrel 70 by caulking, the adhesive G is protected by the caulking portion 83 without being exposed to the outside, and furthermore, the first lens 73 is firmly fixed to the lens barrel 70 by the Caulking portion 83.

Therefore, entry of moisture and dust from between the first lens 73 and the lens barrel 70 can be prevented without using an O-ring.

Further, since the O-ring is not used, it is possible to prevent deterioration of optical performance due to deviation of the first lens 73 in the optical axis direction by receiving a reaction force from the O-ring.

Furthermore, since the O-ring is not used, the number of components does not increase accordingly, and there is no trouble in mounting the O-ring.

Further, by ultrasonically vibrating the first lens 73 by the vibration mechanism 90, foreign matter such as water droplets, muddy water, ice and snow, and frost adhering to the lens surface 73a of the first lens 73 can be removed. In addition, since the O-ring is not used, ultrasonic vibration is not absorbed by the O-ring, and the first lens 73 can be reliably ultrasonically vibrated.

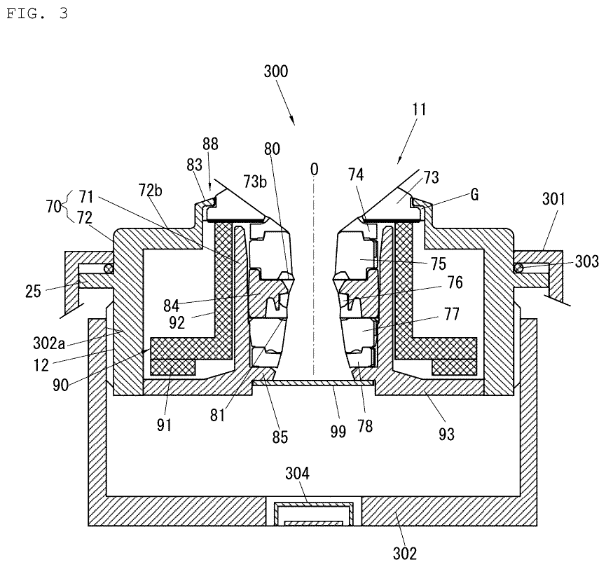

FIG. 3 is a schematic cross-sectional view of a camera module 300 of the present embodiment having the lens unit 11 illustrated in FIG. 1. As illustrated in the drawing, the camera module 300 includes a lens unit 11 to which a filter 99 is attached.

The camera module 300 includes an upper case (camera case) 301 that is an exterior component, and a mount (base) 302 that holds the lens unit 11. Further, the camera module 300 includes a sealing material 303 and a package sensor (image sensor) 304.

The upper case 301 is a member that is engaged with an outer flange 25 provided in a flange shape on an outer peripheral surface of the lens barrel 70 and exposes an end of the lens unit 11 on the object side to cover the other portion. The mount 302 is disposed inside the upper case 301 and has a female screw 302a screwed with a male screw 12 of the lens unit 11. The sealing material 303 is a member interposed between an inner surface of the upper case 301 and the outer peripheral surface of the lens barrel 70 of the lens unit 11, and is a member for maintaining airtightness inside the upper case 301.

The package sensor 304 is disposed inside the mount 302 so as to face the infrared cut filter 99, and is disposed at a position where an image of an object formed by the lens unit 11 is received. Further, the package sensor 304 includes a CCD, a CMOS, or the like, and converts light condensed and arriving through the lens unit 11 into an electrical signal. The converted electrical signal is converted into analog data or digital data which is a component of image data captured by the camera.

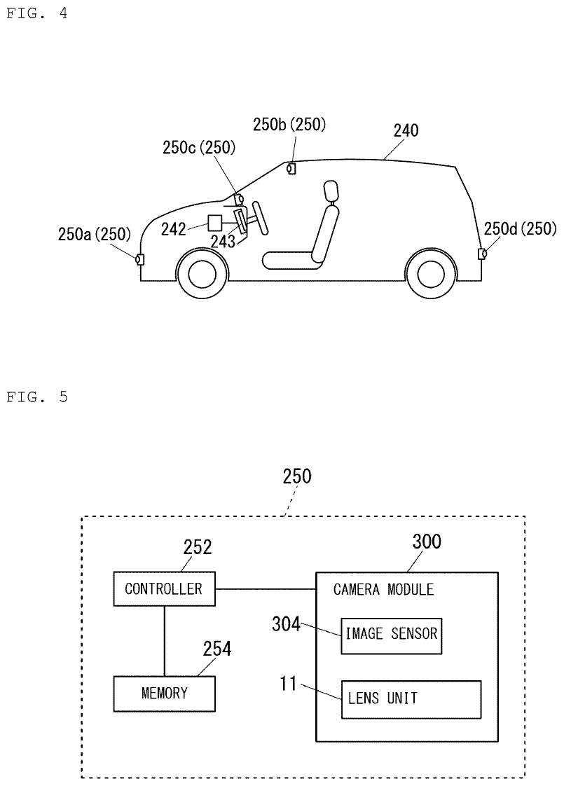

FIG. 4 schematically illustrates a vehicle 240 as a mobile body on which an in-vehicle system (imaging system) including an imaging apparatus 250 including the camera module 300 illustrated in FIG. 3 is mounted. As illustrated, the imaging apparatus 250 can be mounted on the vehicle 240, and FIG. 4 is an arrangement example illustrating a mounting position of the imaging apparatus 250 in the vehicle 240. The imaging apparatus 250 mounted on the vehicle 240 can also be referred to as an in-vehicle camera, and can be installed at various places of the vehicle 240. For example, a first imaging apparatus 250a may be disposed at or near a front bumper as a camera for monitoring the front when vehicle 240 travels. In addition, a second imaging apparatus 250b that monitors the front may be disposed near an inner rearview mirror in the cabin of vehicle 240. The third imaging apparatus 250c may be disposed on a dashboard, in an instrument panel, or the like as a camera for monitoring the driving situation of the driver. The fourth imaging apparatus 250d may be installed at the rear of the vehicle 240 for rear monitoring of the vehicle 240. The imaging apparatuses 250a and 250b can be referred to as front cameras. The third imaging apparatus 250c can be referred to as an in-camera. The fourth imaging apparatus 250d can be referred to as a rear camera. The imaging apparatus 250 is not limited thereto, and includes imaging apparatuses installed at various positions such as a left side camera that images a left rear side and a right side camera that images a right rear side.

An image signal of an image captured by the imaging apparatus 250 can be output to an information processing apparatus 242 and/or a display apparatus 243 in the vehicle 240. The information processing apparatus 242 and the display apparatus 243 constitute an in-vehicle system together with the imaging apparatus 250. The information processing apparatus 242 in the vehicle 240 includes an apparatus that processes the image signal acquired by the imaging apparatus 250, recognizes the image, and assists the driver in driving. Further, the information processing apparatus 242 includes, for example, a navigation apparatus, a collision damage reduction brake apparatus, an inter-vehicle distance control apparatus, a lane departure warning apparatus, and the like, but is not limited thereto. The display apparatus 243 displays an image processed and output by the information processing apparatus 242, but can also directly receive the image signal from the imaging apparatus 250. In addition, the display apparatus 243 may employ a liquid crystal display (LCD), an organic electro-luminescence (EL) display, and an inorganic EL display, but is not limited thereto. The display apparatus 243 can display, to the driver, the image signal output from the imaging apparatus 250 that captures an image of a position difficult to be visually recognized by the driver, such as the rear camera (can output information for the occupant).

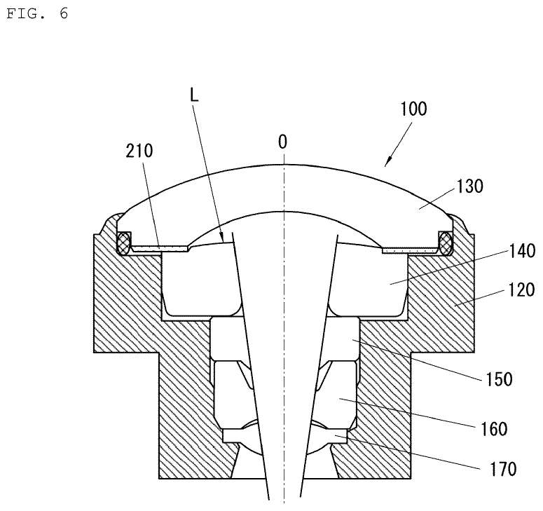

FIG. 5 illustrates a configuration of an imaging apparatus constituting the in-vehicle system illustrated in FIG. 4. As illustrated, the imaging apparatus 250 according to the embodiment includes a controller 252, a memory 254, and the camera module 300 illustrated in FIG. 6 described above.

The controller 252 controls the camera module 300 and processes an electrical signal output from the image sensor 304 of the camera module 300. The controller 252 may be configured as, for example, a processor. Further, the controller 252 may include one or more processors. The processor may include a general-purpose processor that loads a specific program and executes a specific function, and a dedicated processor specialized for specific processing. The dedicated processor may include an application-specific integrated circuit (IC). The application-specific IC is also referred to as an application specific integrated circuit (ASIC). The processor may include a programmable logic device. The programmable logic device is also referred to as a programmable logic device (PLD). The PLD may include a field-programmable gate array (FPGA). The controller 252 may be either a system-on-a-chip (SoC) in which one or more processors cooperate or a system in a package (SiP).

The memory 254 stores various types of information or parameters related to the operation of the imaging apparatus 250. The memory 254 may include, for example, a semiconductor memory or the like. The memory 254 may function as a work memory of the controller 252. The memory 254 may store a captured image. The memory 254 may store various parameters and the like for the controller 252 to perform detection processing based on the captured image. The memory 254 may be included in the controller 252.

As described above, the camera module 300 captures a subject image formed via the lens unit 11 by the image sensor 304, and outputs the captured image. The image captured by the camera module 300 is also referred to as a captured image.

The image sensor 304 may be constituted by, for example, a complementary metal oxide semiconductor (CMOS) image sensor, a charge coupled device (CCD), or the like. The image sensor 304 has an imaging surface on which a plurality of pixels is arranged. Each pixel outputs a signal specified by a current or a voltage according to the amount of incident light. The signal output from each pixel is also referred to as imaging data.

The imaging data may be read out by the camera module 300 for all the pixels and taken into the controller 252 as a captured image. The captured image read for all the pixels is also referred to as a maximum captured image. The imaging data may be read by the camera module 300 for some pixels and captured as a captured image. In other words, the imaging data may be read from pixels in a predetermined capturing range. The imaging data read from the pixels in the predetermined capturing range may be captured as a captured image. The predetermined capturing range may be set by the controller 252. The camera module 300 may acquire a predetermined capturing range from the controller 252. The image sensor 304 may capture an image in a predetermined capturing range of the subject image formed via the lens unit 11.

Note that the present invention is not limited to the embodiments described above, and various modifications can be made without departing from the gist thereof. For example, in the present invention, the shape and the like of the lens, the lens barrel, and the like are not limited to the embodiments described above. In addition, a part or all of the embodiments described above may be combined, or a part of the configuration may be omitted from one of the above-described embodiments without departing from the gist of the present invention.

### REFERENCE SIGNS LIST

11 Lens unit
70 Lens barrel
73 First lens
73b Flat surface
74 to 78 Lens
71 Lens barrel main body
89 Sheet made of metal
90 Vibration mechanism
240 Vehicle (mobile body)
242 Processing apparatus
243 Display apparatus
250 Imaging apparatus
252 Controller
300 Camera module
304 Image sensor
L Lens group
O Optical axis
G Adhesive

1. A lens unit comprising a lens group in which a plurality of lenses is arranged along an optical axis of the lenses, and a lens barrel that houses and holds the lens group, wherein
a black-based metal sheet is bonded to a flat surface facing an image side of a first lens located closest to an object side among the plurality of lenses with an adhesive so that an air layer is not interposed between the flat surface and the metal sheet.

2. The lens unit according to claim 1, wherein the metal sheet is formed in a sheet shape having an annular surface having a same shape as the flat surface, and
the metal sheet is bonded to the flat surface with an adhesive so as to entirely cover the flat surface.

3. The lens unit according to claim 1, wherein the adhesive is an epoxy-based adhesive and has a Young's modulus of 2 to 5 GPa.

4. The lens unit according to claim 1, further comprising a vibration mechanism that vibrates the first lens.

5. A camera module comprising: the lens unit according to claim 1; and an image sensor that converts light condensed through the lens group of the lens unit into an electrical signal.

6. An imaging system comprising:
an imaging apparatus including the camera module according to claim 5 and a controller that controls the camera module and processes an electrical signal output from an image sensor of the camera module;
a processing apparatus that processes an image signal acquired by the imaging apparatus; and
a display apparatus that displays an image processed and output by the processing apparatus.

7. A mobile body comprising the imaging system according to claim 6, wherein the display apparatus outputs information for an occupant.
